(19) United States
(12) Patent Application Publication
(10) Pub. No.: US 2006/0026169 A1
(43) Pub. Date: Feb. 2, 2006

(54) Communication method with reduced response time in a distributed data processing system

(76) Inventor: Roberto Della Pasqua, Savignano Sul Rubicone (RN) (IT)

Correspondence Address: GRAYBEAL, JACKSON, HALEY LLP, 155 - 108TH AVENUE NE, SUITE 350, BELLEVUE, WA, 98004-5901, US

(21) Appl. No.: 11/124,397

(22) Filed: May 6, 2005

Related U.S. Application Data
(63) Continuation-in-part of application No. PCT/EP03/50797, filed on Nov. 5, 2002.

(30) Foreign Application Priority Data
Nov. 6, 2002 (IT) MI2002A002347

(51) Int. Cl. G06F 17/30

(52) U.S. Cl. 707/10

(57) ABSTRACT

A communication method is proposed in a distributed data processing system including a plurality of client computers and at least one server computer. The method includes the steps under the control of the at least one server computer of: receiving a connection request from a client computer, establishing a connection with the client computer in response to the connection request, classifying the connection according to a typology defined by a persistence thereof, responding to the connection request directly or associating the connection with a reading processing entity having a corresponding latency according to the typology of the connection, periodically activating each reading processing entity according to the corresponding latency, verifying a state of each associated connection by the activated reading processing entity, and responding to each further request received in each connection associated with the activated reading processing entity.

### PRIORITY CLAIM

This application claims priority from Italian patent application No. MI2002A002347, filed Nov. 6, 2002, and PCT/EP2003/050797, filed Nov. 5, 2003, both of which are incorporated herein by reference.

### TECHNICAL FIELD

The present invention relates to a communication method in a distributed data processing system.

### BACKGROUND

Distributed data processing systems have become very popular in the last years, particularly thanks to the widespread diffusion of the INTERNET. The INTERNET is a global network with a client/server architecture, in which a great number of users access shared resources managed by server computers (through their own client computers). For example, a user can search and download web pages from the server computers, can use an e-mail service, can exchange messages with another user, can participate in a group of discussion in real-time (chat), can exploit web services based on universal integration protocols, and the like.

The server computers are provided with operating systems specifically designed for this purpose. The structure of a modern network operating system includes a central module (kernel or executive), which has exclusive access to the physical structure (hardware) of the server computer. This module offers services and system primitives for several applications; the applications run in a protected memory area (named user area, or simply user).

It is commonplace the use of technologies known as multitasking (wherein multiple processes work concurrently), multithreading (wherein sub-units of the processes, or threads, working independently are provided), and multi-user (wherein more users can exploit the services offered by the server computer at the same time). For this purpose, the operating systems provide a preemptive (or non-cooperative) scheduler, which allows dividing and distributing processing time units (time-slices) to the different processes and threads (dynamically, preventively and possibly in a deterministic way).

The different applications supported by the INTERNET require each server computer to manage a series of communications with the client computers, typically through the Transmit Control Protocol/INTERNET Protocol (TCP/IP).

Different architectures that are able to support this function have been proposed in the last years for the server computer.

The traditional architectures are called blocked connection architectures, since the different reading and writing operations on each connection with a client computer block the execution flow of an application running on the server computer; for this reason, the primitives of the network operating systems are used for creating concurrence by instantiating different processes or threads.

For example, in a structure with multiple processes a single server application assigns a distinct process to each connection; the process manages, blocking itself, the reading and writing operations on the assigned connection. The executions of the different processes then proceed concurrently. Alternatively, the connections are served by respective threads, which access a shared memory space associated with a single process (wherein the synchronization of the threads is managed controlling their access to the shared memory space).

An alternative model for the management of the communications finds implementation in an architecture known as Single-Process Event-Driven (SPED); in this case, the reading and writing operations of small buffers associated with the different connections are transferred to the operating system, without having the connections to be blocked waiting for their completion (thereby obtaining possibly non-blocking server applications). The process associated with the server application continually checks the state of the non-blocking connections (through an operation known as polling) or is suspended waiting for the occurrence of a state change in a set of connections (through an operation known as select). An evolution of the architecture SPED (named Asymmetric SPED) associates a series of auxiliary processes (or threads) to the main process driven by the input/output events, which auxiliary processes (or threads) are invoked for performing potentially blocking operations (for example, operations on disk). A recently proposed architecture (based on the use of a high-level structure, or design pattern, named Reactor) provides a series of threads in a single process at the application level; each thread manages a set of channels, typically up to 64, each one consisting of an abstraction of network connection or of file on disk. Particularly, an abstraction and encapsulation object of a selector is associated with each thread; the selector controls a channel to be monitored for a specific event required by the server application. The server application is in charge of polling the different instantiated selectors for establishing the occurrence of the events on the channels that have been previously registered.

The currently known architecture that offers the highest scalability is based on the design pattern named ProActor. In this solution, there is provided a queuing structure of the events relating to the completion of the input/output operations (managed at the operating system level in the best hypothesis) and of the processing operations (which in an optimal implementation can be managed by a series of threads at the application level). Each connection as well as each overlapped input/output operation (overlapped I/O) can be associated with an instance of a module ProActor through an identification key, which is returned to the server application when the operation is completed. The module ProActor is in charge of monitoring and managing all the associated elements, and then of creating and sending corresponding events to the server application.

However, none of the architectures known in the art is completely satisfactory. Particularly, the solutions based on multiple processes cause a remarkable overload of the operating system. This is due to the physical limit of the manageable concurrent processes, and to the difficult implementation of efficient methods for the communication among the processes (since each one of them uses a distinct and protected memory space). Moreover, this architecture involves a remarkable waste of processing power and of memory on the server computer) indeed, the creation and the destruction of each process involve the copy of hardware registers and of a stack of the kernel and the applications (with a consequent remarkable use of processing cycles and memory operations).

The solutions based on multiples threads cause a similar performance degradation of the server computer as the number of the threads increases. For example, such degradation is due to the management of the synchronization of the threads, to the context switching that overloads the system (whose scheduler must also manage the distribution of the available time to an excessive number of processing units), to the deadlock of the pipeline in the modern super-scalar server computers, and to the slowdown of the optimal flow of the data processing; moreover, for each connection a remarkable amount of memory is used for hosting the relative thread. This practically limits the maximum number of connections that can be managed by the server computer in a true client/server model. For example (disregarding the limiting factor of the memory and the instability of the system), the theoretical order of connections is equal to the maximum number of threads that can be managed in a process; this maximum number is equal to 2.000 or 3.000 in the architectures with linear memory addressing at 32 bit with 2 GB or 3 GB, respectively, of logical memory assigned to the user area (it is possible, setting configurations of the stack different from the recommend ones, to increase such limit). In any case, the server application becomes inefficient, resource consuming, and logically wrong already allocating a few more than a hundred of threads.

The architectures driven by the events are not free from several drawbacks as well. Particularly, the monitoring at low latency, the management of the overlapping structures, the construction and the dispatching of the events towards the server application for all the associated connections (even if managed at the kernel level) involve the use of remarkable processing resources by the server computer. Different implementations also result not much scalable as the number of users increase, are proprietary and are often made as kernel components (so that they prevent a simple portability of the server application and potentially undermine its protection); each connection in overlapped mode typically requires an allocation of additional memory for the buffers from the non-pageable area of the kernel during the reading and writing operations. Moreover, the management of the processing resources is complicated, as well as the techniques required for implementing quality criteria for the production of software that is error free (debugging, profiling and quality assurance) become complex. In any case, the maximum number of users that can be managed, although higher than can be in the architectures based on the multithreading technology, is relatively low (for example, up to some thousands).

The above-mentioned drawbacks involve an increase of the costs that are needed for managing the communications. Particularly, this requires very powerful (and therefore expensive) server computers; in any case, when the number of users is high their management must be distributed throughout more server computers (with consequent increase of the total cost of ownership, or TOO, which comprises the expenses for the development and/or the software licenses, the cost of the server computers and of all the network devices, and the expenses for their administration).

In substance, none of the solutions known in the art offers optimal results in terms of scalability, flexibility, performance, security and portability of the server application.

### SUMMARY

Briefly, an aspect of the present invention provides a communication method in a distributed data processing system including a plurality of client computers and at least one server computer, the method including the steps under the control of the at least one server computer of: receiving a connection request from a client computer, establishing a connection with the client computer in response to the connection request, classifying the connection according to a typology defined by a persistence thereof, responding to the connection request directly or associating the connection with a reading processing entity having a corresponding latency according to the typology of the connection, periodically activating each reading processing entity according to the corresponding latency, verifying a state of each associated connection by the activated reading processing entity, and responding to each further request received in each connection associated with the activated reading processing entity.

Moreover, an aspect of the present invention proposes a program for performing the method and a product embodying the program; an aspect of the invention also includes a corresponding server computer and a distributed data processing system wherein the server computer is used.

### BRIEF DESCRIPTION OF THE DRAWINGS

Further features and the advantages of the solution according to the present invention will be made clear by the following description of a preferred embodiment thereof, given purely by way of a non-restrictive indication, with reference to the attached figures, in which:

FIG. 1a illustrates a diagrammatical representation of a data processing system wherein a method according to an embodiment of the invention is applicable;

FIG. 1b is a schematic block diagram of a server computer of the system;

FIG. 2 shows the main software components used for implementing the method; and

FIGS. 3a-3d illustrate different activity diagrams describing the logic of a method of communication implemented in the system.

### DETAILED DESCRIPTION

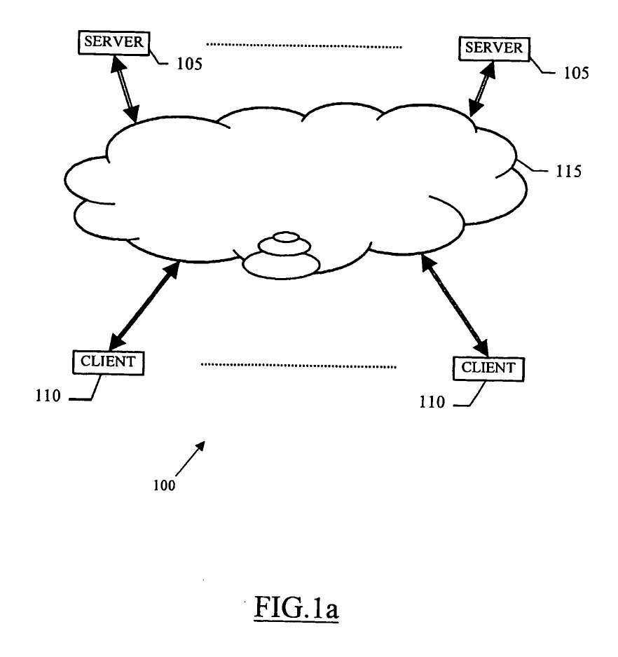

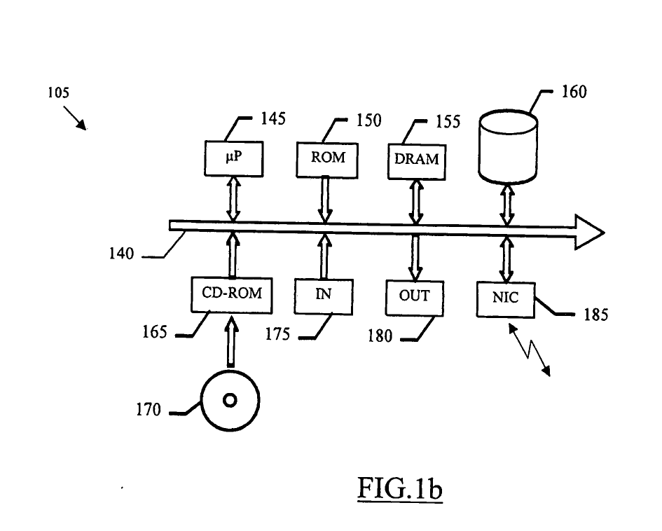

With reference in particular to the FIG. 1a, a data processing system 100 with a distributed architecture (typically, INTERNET-based) is shown. The system 100 has a client/server structure; multiple server computers 105 support shared resources for multiple client computers 110, which access the shared resources through a communication network 115.

The structure of a generic server 105 is illustrated in FIG. 1b. The server 105, for example, consisting of a Personal Computer (PC), is formed by several units that are connected in parallel to a communication bus 140. In detail, a microprocessor 145 controls operation of the server 145, a Read-Only Memory (ROM) 150 contains basic code for a bootstrap of the server 105 and a Random Access Memory (RAM) 155 is directly used as a working memory by the microprocessor 145. Several peripheral units are further connected to the bus 140 (through respective interfaces). Particularly, a mass memory consists of a hard-disk 160 and of a driver 165 for reading optical disks (CD-ROMs) 170. Moreover, the server 105 includes input devices (IN) 175 (such as a keyboard and a mouse), and output devices (OUT) 180 (such as a monitor and a printer). A network card (NIC) 185 is used for connecting the server 145 to the other computers of the system.

In any case, the concepts of the present invention are also applicable when the system has a different structure (for example, based on a local network or LAN), or when a different number of servers is provided (down to a single one); similar considerations apply if the server has another architecture or includes different units, if the clients are replaced with equivalent devices (such as a palmtop computer or a mobile telephone), and the like.

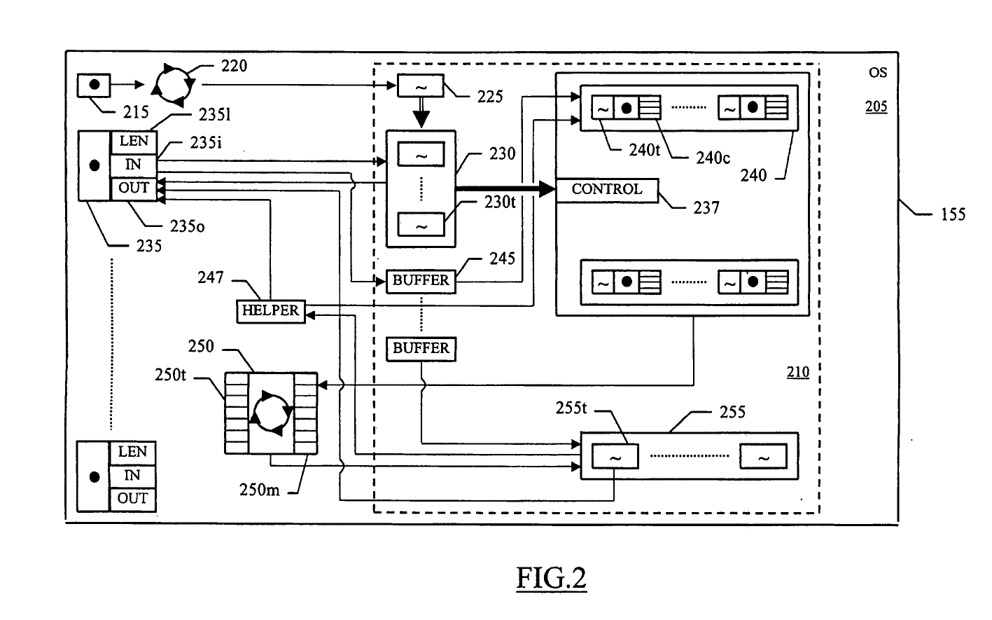

Passing now to FIG. 2, a partial content of the working memory 155 of the server during its operation is shown. The information (programs and data) is typically stored on the hard-disk and loaded (at least partly) into the working memory when the programs are running. The programs are initially installed to the hard-disk from CD ROM.

An operating system (OS) 205 (for example, Microsoft Windows NT, Linux, Sun Solaris or Berkeley *BSD) defines a software platform on top of which different application programs run; the operating system 205 consists of a central module (kernel), which provides all the basic services required by the other components of the operating system 205. An application 210 is used for managing the communications with the several users that are active on the clients of the system.

The server communicates with the other computers of the system through the protocol TCP/IP, which implements a socket mechanism (BSD socket). A socket is a virtual connection that defines an endpoint of a communication; the socket is identified by a network address and by a port number (which indicates a corresponding logical communication channel).

A specific socket 215 (for example, associated with the port 80) works as a listening socket, which is addressed by each client of the system desiring to establish a connection with the server.

A selector 220 at the level of the operating system 205 continually checks the listening socket 215, in order to detect the connection requests from the clients. The selector 220 notifies each connection request to the application 210. Particularly, the connection request is provided to a sorting thread 225 (with critical priority and timers at high resolution). The sorting thread 225 (after selecting and then accepting the new input) associates the connection request to a module 230 consisting of a pool of analysis threads 230t; the dimension of the thread pool 230 is defined dynamically according to the workload of the server.

The analysis thread 230t that has taken in charge the request handle the management of the connection with the client; particularly, the analysis thread 230t registers a corresponding communication socket 235 (preloaded into an encapsulation object in the analysis thread 230t) with the new directives dictated by the sorting thread 225 for the communication with the client. The socket 235 is associated with an input buffer 235i and with an output buffer 235O for blocks of data (or packets) received from the client or to be sent to the client, respectively; an index 2351 identifies the amount of bytes (and therefore of characters) that are present in the input buffer 235i. The buffers 235i and 235O are of small dimensions (for example, 8 kbytes), and they are managed at the level of the operating system 205 directly.

The analysis thread 230t classifies the connection according to its expected persistence. Particularly, the analysis thread 230t determines the communication protocol used and the type of operation required. The connection is considered non-persistent if it involves one or more immediate responses. For example, the connection is non-persistent when it is closed once a respective response has been transmitted (single immediate response connection); the connection is also non-persistent when it is left open for satisfying requests following the first one from the same client (with a process known as tunneling and pipelining), up to the reaching of an inactivity time-out or up to the receiving of an end-of-sequence command in a pre-defined protocol (multiple immediate response connection). In all the other cases, instead, the connection is considered persistent.

For example, a request of a standard web page involves a single immediate response connection. An authentication procedure (handshaking), such as for logging in a chat, requires a multiple immediate response connection (wherein the client and the server exchanges a series of messages logically in rapid sequence). Conversely, the use of web services (for example, the services known as soap and xml on http protocols) for the use of Business-To-Business (B2B) or universal data exchange applications, the communications between computers and networks, a session for sharing a graphic blackboard with another client, or the exchange of messages in a chat involve persistent connections.

The persistent connections are partitioned into different categories, according to their logic characteristics. The aim is that of associating an optimal management latency (as described in the following) with each persistent connection, which latency is defined according to the characteristics of the protocol and to the type of operations to be performed. For example, if the connection relates to communications among people (such as the exchange of messages or a chat) it is associated with a latency having a high value (typically from 0,2 s to 2 s, and preferably 0,5-1 s). A connection relating to the use of an electronic blackboard is instead associated with a latency of some tens of ms (so as to ensure at least 20-25 video refreshing per second). Conversely, a connection relating to communications that do not involve any human being intervention (such as in an application of automatic software distribution) is associated with a very low latency (typically few ms).

If the connection is non-persistent (single immediate response connection or multiple immediate response connection), the analysis thread 230t that has taken in charge the corresponding request directly manages its processing (as described in detail in the following). On the contrary, the management of the persistent connection (classified according to its ideal latency) is transferred to a reading module.

The reading module consists of a control structure 237 for a series of thread pools 240 for the different categories of connections; each thread pool 240 is associated with a predefined activation latency. The thread pool 240 is formed by one or more reading threads 240t (which are managed dynamically as described in detail in the following). Each reading thread 240t is associated with a table 240c; for each connection managed by the reading thread 240t, the table 240c stores a reference to a corresponding structure 245. Preferably, the structure 245 includes a pointer to the socket 235; moreover, the structure 245 is provided with a multiple buffer (with respective indexes), which is used for gathering the received packets logically (without any physical movement) so as to define input messages.

Each reading thread 240t detects the packets received in the corresponding input buffer 235i exploiting a helping module 247 included in the operating system 205. The reading thread 240t then notifies the completion of one or more input messages to a writing module (preferably at the level of the operating system 205). The writing module consists of a selector 250 that manages a FIFO queue 250m containing references to external structures; for example, this allows activating the writing module sending the notification of a structure that contains a reference to the input message, a command identifying the type of operation to be performed, and the type of event to be returned. A pool 255 of execution threads 255t at the level of the application 210 (dynamically dimensioned according to the workload of the server) compete on the queue 250m. The activation of the execution thread is directly managed by the selector 250. For this purpose, the selector 250 controls a LIFO queue 250t, which includes an identifier for each available execution thread 255t. The execution thread 255t is in charge of parsing and rendering the input message stored in the structure 245. Each output message (if any) generated in response to the input message is inserted (either directly or in sequential portions, or chunks) into the output buffers 235O associated with the clients to which the output message is to be sent by the execution thread 255t; for this purpose, the execution thread 255t can also exploit the helping module 247.

In any case, the concepts of the present invention are also applicable when the programs are provided on any other computer readable medium (such as a DVD), when the programs and the data are structured in a different way, or when other modules or functions are provided. Similar considerations apply if the latencies are updated dynamically according to the workload of the server, if the number of threads in each pool is defined statically, if different data structures or queues are used, and the like. Alternatively, the system supports communication entities equivalent to the sockets, the threads are replaced with other processing entities (such as agents, deamons, or processes), the connection is directly managed by the analysis thread even when it has a low persistence (i.e., lower that a preset threshold value).

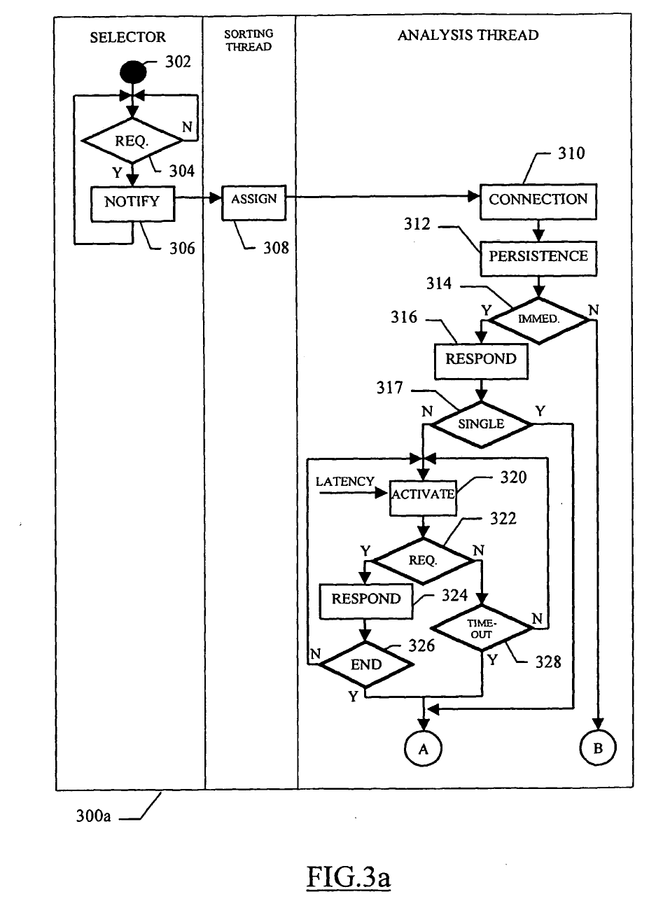

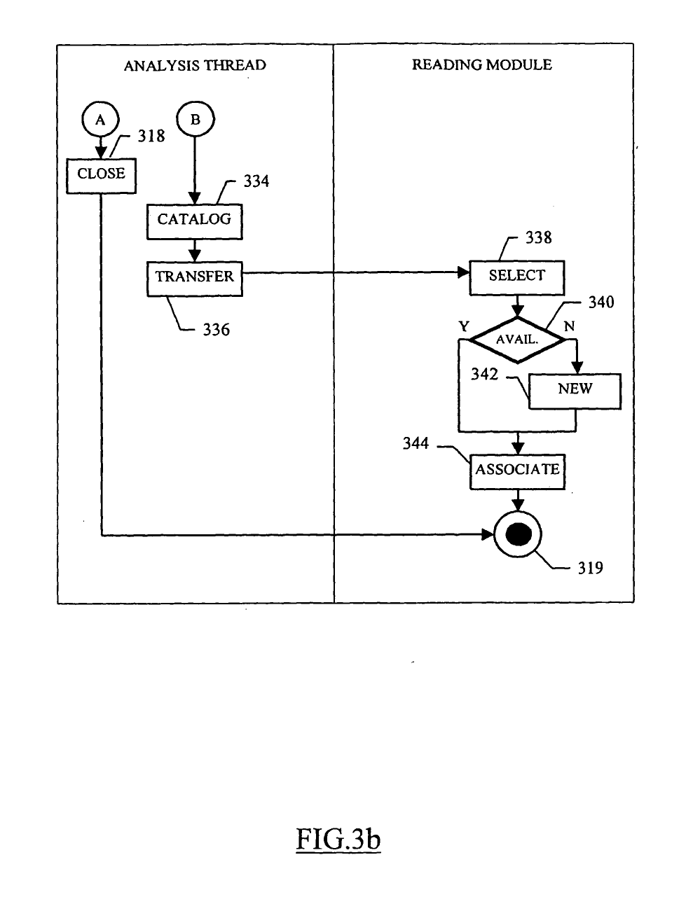

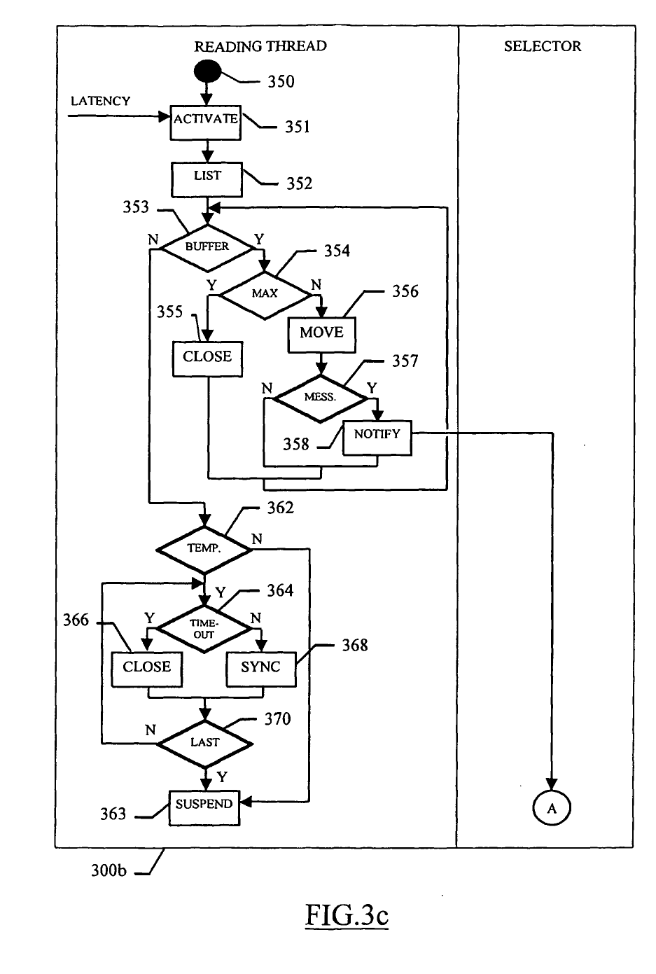

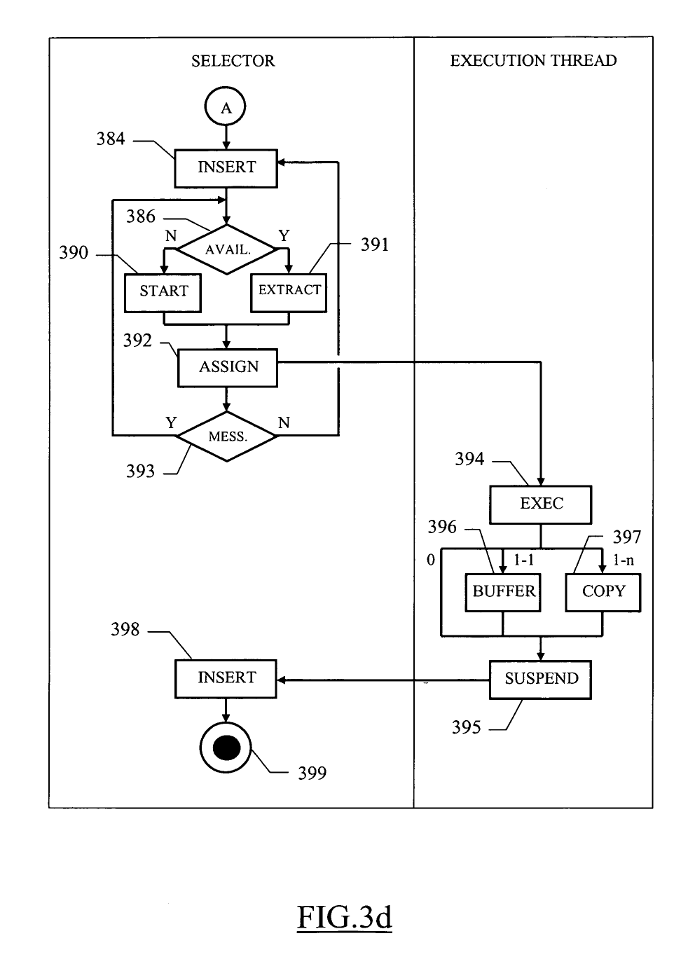

Moving now to FIGS. 3a-3b, the flow of activity of a communication process 300a implemented in the above-described system is shown. The process 300a begins at the black starting circle 302 in the swim-lane of the selector (at the operating system level) associated with the listening socket. The selector at block 304 continually checks the state of the listening socket. As soon as a connection request is received from a client, the process descends into block 306 wherein the selector notifies the request to the sorting thread.

The flow of activity proceeds to block 308 in the swim lane of the sorting thread, wherein the connection request is accepted and prepared in a respective communication object of a free analysis thread (with the sorting thread that is immediately available to receive new connection requests). Passing to block 310, the selected analysis thread uses its own connection preloaded with the specifics dictated by the sorting thread. The analysis thread then classifies the connection at block 312 according to its persistence.

The process branches at the test block 314. If the connection is non-persistent (single immediate response connection or multiple immediate response connection), the flow of activity continues to block 316 wherein the analysis thread directly responds to the request of the client.

The process then verifies at block 317 whether the connection is at single immediate response. If so, the connection is closed at block 318 (releasing the analysis thread); the flow of activity then ends at the concentric white/black stop circles 319. Conversely, if the connection is at multiple immediate responses the analysis thread waits for new requests from the client with a preset latency (for example, 1 ms).

Particularly, the analysis thread is activated at block 320 once the period of time corresponding to this latency has expired. A test is made at block 322 to verify whether a new request has been sent by the client. If so, the analysis thread immediately responds to the client at block 324. If the analysis thread then determines at block 326 that the procedure corresponding to the connection has not been completed, the process returns to block 320 (for processing a possible next command at the expiry of the respective latency); conversely (for example, if a command pre-defined by the protocol for ending the sequence has been received), the connection is closed at block 318.

Considering block 322 again, if no request has been sent by the client, the analysis thread verifies at block 328 whether a preset time-out (for example, 1 minute) from the receipt of a last request from the client has elapsed. If so, the connection is closed at block 318; conversely (i.e., whether the connection is still active), the flow of activity returns to block 320.

With reference to block 314 again, if the connection is persistent it is classified at block 334 according to its logic characteristics. Passing to block 365, the management of the connection is then transferred to the reading module. In response thereto, at block 338 the control structure of the reading module selects the thread pool corresponding to the category of the connection. Proceeding to block 340, it is then verified whether the selected thread pool includes an available reading thread (i.e., a reading thread that currently manages a number of connections lower than a preset maximum value, such as 250-1.000). If not, a new reading thread is activated at block 342, and the process then passes to block 344; conversely, the flow of activity descends into block 344 directly. Considering now block 344, the table associated with an available reading thread (in the thread pool corresponding to the category of the connection) is updated accordingly, inserting the references to the structure of the connection. The process then ends at the final block 319.

Passing now to FIGS. 3c-3d, a management process 300b of the requests coming from the clients begins at the black start circle 350 in the swim-lane of a generic reading thread.

The reading thread is activated at block 351 once the period of time corresponding to its latency has elapsed. Passing to block 352, the reading thread receives a list from the helping module of the operating system; this list contains an indication of the corresponding input buffers that are not empty. A test is made at block 353 to verify the exit condition of a cycle 354-358, which is reiterated for each input buffer of the list.

With reference now to block 354, the reading thread verifies whether the average frequency of the packets received from the client associated with the input buffer has reached a preset threshold value (typically defined according to the number of received packets or to their total dimensions). If so, the connection is passed to a security management module (and probably closed) at block 355; the process then returns to block 353 for processing a next input buffer of the list. Conversely, the process continues to block 356, wherein the packets are moved from the input buffer to the corresponding input structure at the application level (updating the associated indexes accordingly); preferably, in the case of a scatter/gather native architecture at the operating system level, this simply involves the updating of the indexes without the physical movement of any packet. A test is then made at decision block 357 to verify whether the packets in the input structure complete one or more messages. If not, the process returns to block 353. Conversely, the process passes to block 357 wherein the completion of the input message (or messages) is notified and queued to the writing module; this allows releasing the reading thread immediately, with the reading thread that will only receive a notification of the possible success of the queuing of a logic phase abstraction thereby defined. The process then returns to block 353.

Considering the test block 353 again, as soon as the iteration of the list is finished (i.e., all the input buffers have been processed or the list is empty) the process descends into block 362. If a timing signal for the management of sessions implemented by the above-described connections has not been received in the meantime, the reading thread suspends its execution at block 363. Conversely (i.e., whether the period of time corresponding to a latency of the timing signal, such as 1 minute, has elapsed) the analysis thread proceeds with an iteration of all the associated sessions (starting from the first one). Particularly, the reading thread verifies at block 364 whether a preset time-out (for example, higher than 1 minute) from the receipt of a last synchronization signal from the corresponding client has elapsed (or if the state of the socket indicates that the session is ended). If so, the connection is closed at block 366 (releasing the respective record in the table managed by the reading thread); conversely (i.e., whether the connection is still active), the reading thread at block 368 sends a new synchronization alignment request to the client.

In both cases, the reading thread verifies at block 370 whether the last connection has been processed. If not, the flow of activity returns to block 364 (for continuing the iteration with the next session of the list). Conversely, the process is suspended at block 363.

Moving to the swim-lane of the selector of the writing module, a reference to the input message (with the respective operation to be performed) is inserted into the corresponding FIFO queue at block 384. The selector of the writing module then verifies at block 386 whether an execution thread (at the application level) is suspended and available. If not (i.e., the corresponding LIFO queue is empty), the process at block 390 creates a new execution thread, which is then added to the respective pool and immediately used for the processing; conversely, the first available execution thread is activated at block 391, and the respective identifier is extracted from the LIFO queue. Proceeding to block 392, in both cases the execution thread is assigned to the management of the first input message indicated in the FIFO queue (or of a different operation specified by an equivalent logic phase abstraction).

The process then continues to block 393; the selector of the writing module verifies whether there are further input messages (or logical phases), which are still waiting to be processed. If not (i.e., the FIFO queue is empty) the flow of activity returns to block 384 (waiting for new operations to be performed). Conversely, the flow of activity returns to block 386 for processing further operations.

Passing now to the swim-lane of the activated execution thread, the operations associated with the input message are performed at block 394 (in response to the assignment of block 392). The flow of activity then branches according to the type of processing of the input message. Particularly, if the processing does not involve the dispatch of any output message, the method directly descends into block 395 (described in the following). Conversely, if the dispatch of an output message to a single client (message one-to-one) is required, the method passes to block 396 wherein the packets that form the output message are loaded in succession into the output buffer associated with this client. If instead the dispatch of the same output message to more selected clients (message one-to-many) is required, the method passes to block 397 wherein the execution thread sends a corresponding command to the helping module of the operating system (which command includes the output message and a list of the selected clients); in response thereto, the helping module directly manages the duplication and the loading of the message into the output buffers associated with the selected clients. In both cases, the method then passes to block 395; in this way, the execution thread is immediately released without waiting for the duplication and/or the transmission of the output messages, but only for the success of the queuing and possible error identifiers.

Once the processing of the input message has been completed, the process merges at block 395 wherein the execution thread suspends its execution. As a consequence, the identifier of the execution thread that has been suspended (and that is then available for processing other input messages again) is re-inserted into the LIFO queue at block 398 (in the swim-lane of the selector of the writing module). The process then ends at the concentric white/black stop circles 399

In any case, the concepts of the present invention are also applicable when equivalent flows of activity are envisaged, or when the processes implement additional functions (for example, a filter structure for processing the input messages with different priorities or a pre-analysis structure for the breakdown of multiple input messages received in a single block of bytes). Similar considerations apply if each reading thread manages a different number of connections, if the time-out is set dynamically (or even if it is not supported), if a different maximum frequency of input packets is allowed, and the like. Alternatively, further sorting threads (typically, up to 2 per processor) are provided for satisfying a high frequency of the input messages, or the operations are left pending in the FIFO queue when no execution thread is available and a maximum number of usable threads has been reached (so as to be handled by the next first thread that will be released by the execution in progress). Moreover, each execution thread can perform the analysis of the input message building a temporary external structure where multiple references to key words with the relative values are inserted (avoiding copying the information for each manipulation), for example, thereby accelerating the operation on a typical header RFC2 616 of thousand of times; different dynamic cache memories with CPU-MMU alignment techniques and zero-copy can be used to accelerate and to optimize the dispatching of static documents, or the fetching of repetitive information.

Experimental results have shown that the devised architecture is able on common available hardware (such as processors with architecture Intel i386 compatible of 6ˆ and 7ˆ generation, for example, Intel Pentium III and Amd Athlon) to exhaust the logical addressing at 15 or 16 bits of the communication protocol TCP/IP, thereby succeeding in loading and managing more than 32.000 or 64.000 users, respectively, in real-time.

The test messaging application, provided with a gateway HTTP1.1 (RFC2 616 compliant) and a proprietor gateway of instant messaging (with latency set at 0, 5 seconds), has been made in environment MS NT 5.0 and Win32-Winsock 2.2 API (proprietary implementation BSD API); the application subjected to load test and stress, although not implementing the helping module in the operating system, shows an increase in the users of 500-5.000%, a saving of memory in the order of 1.000-2.000%, an execution time of the writing iterative operations lower than 2.000-2.300% (in comparison with the solutions known in the art), and 100% of success in all the operations; moreover, the application has shown a throughput higher than 500% in comparison with the most popular web server open source (Linux 2.4, Apache 1.3 and multitasking model with blocking connections) as far as the RAW efficiency of the I/O path at low latency is concerned for satisfying the single response requests (simulating input and output documents with a dimension lower than 1460 bytes, such as MTU Ethernet units of 1500-90 Header TOP).

Moreover, the pre-analysis and multithreading processing module has shown a throughput higher than 40% in comparison with an equivalent implementation thereof made in ProActor overlapped I/O.

The above-mentioned data shows the technical effects that are achieved logically separating the management of the connections according to their persistence and latency, using an input thread pool to satisfy the immediate requests, and two distinct and asynchronous reading and writing modules particularly advantageous for the handling of small packets of bytes at high latency as in the case of instant messaging systems.

Those results also allow conceiving that the subject solution will be even more scalable in the future protocols with a logical addressing higher than 16 bits and in implementations of the communication stack specifically designed for the subject invention.

More generally, an aspect of the present invention proposes a communication method for use in a distributed data processing system; the system includes a plurality of client computers and one or more server computers. This method provides a series of steps that are carried out under the control of the server computer. The method start with the step of receiving a connection request from a client computer. A connection is established with the client computer in response to the connection request. The method then provides classifying the connection according to a typology defined by a persistence thereof. The server computer responds to the connection request directly or associates the connection with a reading processing entity having a corresponding latency according to the typology of the connection. Each reading processing entity is activated periodically according to the corresponding latency. The activated reading processing entity verifies a state of each associated connection. The method ends with the step of responding to each further request received in each connection associated with the activated reading processing entity.

The proposed architecture strongly reduces the overload of the server computer; this allows optimizing the use of the available resources (such as, for example, the processing power and the memory of the server computer).

The solution according to an embodiment of the invention makes it possible to remarkably increase the number of users that can be managed by the server computer for the same structure.

Moreover, the high number of users manageable in a single server computer allows creating Presence Provider or Instant Messaging applications, without loading applications listening on each client computer of the network (as it is typical in the prior art), but only using simple “passive” clients. In this way, the security of the network is unaffected and the actual client/server model is maintained for an absolute centralization of the information management. This solution involves a significant reduction of the costs required to manage the communications. Particularly, the proposed architecture allows using processing systems less powerful (and then cheaper); moreover, most practical applications are manageable on a single server computer (with consequent reduction of the costs for the software, the network devices and their administration).

This result is achieved without the need to move the processing from the application level to the operating system level (even if such possibility is not excluded). The devised technique uses simple non-blocking connections that do not generate any event to the server application (as, for example, the asynchronous or in ProActor overlapped I/O connections) and leave the management of the I/O primitives only to the kernel (particularly, eliminating the processing of possible design patterns); therefore, the invention attains an exceptional scalability of the server application maintaining the same portable and secure.

The preferred embodiment of the invention described above offers further advantages.

Particularly, the server directly responds to the connection requests if the connection involves one or more immediate responses.

This allows managing the non-persistent connections in a very efficient way.

Advantageously, the non-persistent connections include single immediate response connections.

The proposed solution avoids any waste of resources for the connections that are closed immediately after transmitting the respective response.

As a further improvement, the non-persistent connections also include multiple immediate response connections, which are closed when an inactivity time-out is reached or an end-of-sequence command (defined by the protocol) is received.

Such feature offers the advantage of maintaining those connections open in a very simple way, so as to satisfy the requests following the first one very quickly; however, this result is achieved maintaining the respective resources busy only for the time that is strictly necessary and expected.

Alternatively, the server directly responds to the connections having a persistence lower than a threshold value, only the single immediate response connections are considered non-persistent, or the multiple immediate response connections are closed in another way.

In a particular embodiment of the invention, the latency of the reading threads is higher than 0, 2 s (thereby bringing the reaction times for input messages in a range from Os to 0, 2 s).

Such value is particularly advantageous in applications involving communications among people (such as a business messaging application or a chat), which applications require the handling of small, but several, packets) in this case, the increase of the response time is negligible for the users, and it is more than compensated for by the high improvement of the server performance.

Preferably, different reading threads (with corresponding latencies) are provided for different categories of connections, defined according to their logic characteristics.

This additional feature allows performing a logical distinction of the different connections so as to decide their best handling.

In any case, the solution according to an embodiment of the present invention is also suitable for different applications (for example, with communications that do not involve any human being intervention and wherein the latency has a lower value), or even using the same latency for all the connections.

Advantageously, the listening socket is controlled by a selector at the operating system level, which selector notifies each connection request to a sorting thread at the application level.

This allows managing the connection requests from the different clients in a very efficient way.

As a further improvement, the sorting thread notifies the connection requests to a pool of analysis threads, which then manage the connection.

The proposed feature allows releasing the sorting thread immediately. Moreover, when the analysis threads have a respective communication object that is pre-loaded, it is possible to avoid the creation and the destruction of a socket and the corresponding encapsulation structure for each operation (except when this is strictly necessary).

Preferably, the reading module includes a series of reading thread pools; the dimension of each pool is managed dynamically so as not to exceed a maximum number of connections assigned to each reading thread.

This structure ensures a good workload balancing in the reading module.

Moreover, this allows managing the reading thread pools through gateways that use the same behavioral model between different technologies and protocols. These different types of gateways allow, for example, building a messaging server application that provides the management and the opaque integration of clients based on different technologies, such as a web page, or an application specifically built for operating on a traditional PC, on a Tablet PC, on a palm top (PDA), or on a cellular telephone, and so on. An exemplary gateway allows simulating Push Technology behaviors in Pull Technology architectures or StateLess architectures, such as the HTTP and the World Wide Web. This last feature makes it possible to transform the typical web sites into light, interactive, always up-to-date and “zero-configuration” Graphical User Interfaces (GUIs). This solution is alternative to the one described above, wherein a native protocol is used that allows the reading module to manage the reading operations and the sessions on duplex connections; in this way, a single connection is necessary to receive input messages from the client and to return output messages to the same.

In any case, the solution according to an embodiment of the present invention leads itself to be implemented even detecting the connection requests in a different way, directly analyzing the connections by the reading module, with a reading module that is structured in a different way (for example, with the dimension of the different reading thread pools that is pre-defined), or without any gateway for the reading thread pools.

In a preferred embodiment of the invention each reading thread, when activated, only detects each input packet in the buffers of the associated connections (at the operating system level) and moves these packets to a corresponding input structure (at the application level), inter-alias avoiding the management of traditional and costly methods for the collection of input information from the connections; as soon as one or more input messages have been completed, the reading thread notifies the execution module accordingly. In this way, the different reading threads are not blocked on the input buffers. Conversely, they only queue the packets up to the creation of a logical phase; this logical phase is then notified to the execution module, and the reading thread immediately returns to its execution (before the analysis and processing of the logical phase). Moreover, the devised structure eliminates most of the context switching that are required in the known solutions for managing the input message coding. Accordingly, the effectiveness of the system is strongly increased.

As a further improvement, each reading thread receives a list of the input buffers that are not empty from the operating system directly.

Therefore, the state of all the input buffers associated with the reading thread is verified with a single context switching; moreover, this allows saving the iteration of all the input buffers.

Advantageously, the connection is automatically closed when the frequency of the input messages exceeds a threshold value; for example, this condition is detected when the number of the input messages or their total dimension exceeds a preset value, or when one or more clients send undesired packets to a single addressee. This allows preventing high-level flooding attacks to the server.

A way to further improve the proposed solution is that of processing the input messages by corresponding threads; the input messages and the available threads are directly managed by a selector at the operating system level. The devised structure removes the different context switching (from application to operating system, and vice-versa), which are required in the known solutions for managing the processing of the input messages. As a consequence, the effectiveness of the system is strongly increased.

Moreover, it is possible to obtain substantially deterministic response times of the server and to implement a client-server model among the modules of the architecture. This features add management capability to the whole processing flow making it possible to correct errors, to forecast different behaviors according to non-homogenous workloads, to reach a reliability of the server application close to 100% thanks to the process of resolving the single instructions into abstraction and aggregation structures queued to the processing entities with priority management algorithms; these results are in integration to pooling, dynamic buffering, auto-tuning, error tolerance, load balancing, clustering, symmetrical multi-processing, bandwidth throttling, dynamic thread scheduling, output information resolution updating (where applicable) techniques, and so on.

Advantageously, the execution thread causes the insertion of any output message into the corresponding buffer (with the transmission that is then managed at the operating system level directly); moreover, it is also possible to gather small output memory blocks (if near in time) that are addressed to the same client (thereby avoiding multiple output operations). In this way, a remarkable improvement of the dispatching speed of the output messages is obtained.

In a preferred embodiment of the invention, the execution thread requires the duplication and the insertion of the output message into more buffers to the operating system directly.

The proposed feature allows managing one-to-many messages with a single call to the operating system. For example, this advantage is particularly important in a chat, wherein the same message must be sent to a high number of addresses (even if other applications are not excluded).

Moreover, this reduces a closing time of a user list of a possible real-time messaging application thereby improving its overall stability (since during an iteration of the list for the dispatching of any output message it is not possible to perform updating operations, such as the addition or the deletion of users). In a preferred application, the above-referenced user collections are asynchronous and atomized with techniques allowing the simultaneous execution of different iterations on lists even comprising user duplications.

In any case, embodiments of the present invention are suitable to be put into practice also verifying, by the reading threads directly, whether each corresponding input buffer is not empty, or whether a corresponding reading state has been set by the operating system; alternatively, the logical phases are handled in a different way, the input messages are assigned to the execution threads in another way, or different techniques are used for transmitting the output messages.

Advantageously, the solution according to an embodiment of the present invention is implemented with a computer program, which is provided as a corresponding product stored on a suitable medium.

Alternatively, the program is pre-loaded onto the hard disk, is sent to the server through a network, is broadcast, or more generally is provided in any other form directly loadable into a working memory of the computer. However, the method according to an embodiment of the present invention leads itself to be carried out with a hardware structure (for example, integrated in a chip of semiconductor material).

Moreover, the devised solution can be provided with a number of further improvements.

For example, the selector of the writing module serializes and parallelizes the concurrence of the execution threads on the scheduler thanks to its real-time capabilities; for example, this result is achieved preventively assigning the time-slices of only two threads at a time in sequence and at very high priority, and queuing the remaining time units to be assigned to all the threads. In this way, it is possible to accelerate the processing referring to the threads, avoiding the processing time wasted by the scheduler to manage the distribution of the time-slices to different simultaneous threads and assigning more CPU time to the subject processing; this also reduces the negative effects caused by the assignment of unused processing resources (for example, because of the attribution of a time-slice to a thread that is immediately suspended).

Furthermore, it is possible to use modules that implement a real-time indexing, classification and compression of all the input information (thanks to the use t of an index that is distributed with hashing and cryptographic algorithms among possible servers, in addition to non-static classification techniques); this allows, in addition to storing to mass devices with common standards (sql platforms), searching the most recent information, in real-time, that is passed through the memory of the server computers forming the network.

Moreover, agents provided with artificial intelligence are extended (with respect to the solutions known in the art) with the ability of integrating dynamic data sources (creating, such as in a chat program, helping agents or virtual commerce agents).

At the end, a specific algorithm is used for performing the different operations in the memory faster. This algorithm uses all the extended registers of the modern CPUs; the transfer of a block of data is dynamically vectorized according to the dimension of the block. If the data is of small dimension and non-aligned, it is transferred one byte at a time. If the data is of greater dimension it is transferred using the maximum amount of extended registers aligned according to the optimal dimensions of the system CPU-MMU; the remaining bytes are then transferred one at the time in a sequential way so as not to cause the regression of the super-scalar pipeline. Alternatively, only some of those features are provided (down to none of them). Vice-versa, it should be noted that the additional features could be used (alone or in combination to one another) even in different architectures. For example, the solution relating to the simulation of a Push Technology structure in a Pull Technology environment or the solution relating to the agents provided with artificial intelligence can also be used in network servers known in the art.

Naturally, in order to satisfy local and specific requirements, a person skilled in the art may apply to the solution described above many modifications and alterations all of which, however, are included within the scope of protection of the invention as defined by the following claims.

What is claimed is:

1. A communication method in a distributed data processing system including a plurality of client computers and at least one server computer, the method including the steps under the control of the at least one server computer of:
receiving a connection request from a client computer,
establishing a connection with the client computer in response to the connection request,
classifying the connection according to a typology defined by a persistence thereof,
responding to the connection request directly or associating the connection with a reading processing entity having a corresponding latency according to the typology of the connection,
periodically activating each reading processing entity according to the corresponding latency,
verifying a state of each associated connection by the activated reading processing entity, and
responding to each further request received in each connection associated with the activated reading processing entity.

2. The method according to claim 1, wherein the step of responding to the connection request directly or associating the connection to the reading processing entity includes:
responding to the connection request directly if the connection involves at least an immediate response, or
associating the connection with the reading processing entity otherwise.

3. The method according to claim 2, wherein the step of responding to the connection request directly is performed if the connection involves a single immediate response.

4. The method according to claim 2, wherein the step of responding to the connection request directly is performed if the connection involves a plurality of immediate responses, the method further including the step of closing the connection when an inactivity time-out is reached.

5. The method according to claim 1, wherein the latency is higher than 0,2 s.

6. The method according to claim 1, wherein the step of associating the connection with the reading processing entity includes selecting one among a plurality of reading processing entities, each one having a corresponding latency, according to logical characteristics of the connection.

7. The method according to claim 6, wherein the step of receiving the connection request includes:
checking a listening communication entity to which the connection requests are sent by each client computer at an operating system level, and
notifying each detected connection request to a sorting processing entity at an application level.

8. The method according to claim 7, wherein the step of establishing the connection includes:
the sorting processing entity notifying each connection request in succession to one of a plurality of analysis processing entities at the application level, and
each analysis processing entity allocating a communication entity in response to the connection request.

9. The method according to claim 8, wherein the step of associating the connection to the reading processing entity includes:
selecting one among a plurality of pools of reading processing entities for corresponding categories of logic characteristics of the connections,
activating a new reading processing entity for the selected pool if all the reading processing entities of the selected pool are associated with a preset maximum number of connections, and
associating the connection to one of the reading processing entities of the selected pool associated with a number of connections lower than the preset maximum number.

10. The method according to claim 9, wherein the step of verifying the state of each associated connection by the activated reading processing entity includes:
checking a state of an input buffer managed at the operating system level for each communication entity associated with the connection,
transferring each block of data present in the input buffer to a corresponding input structure at the application level,
verifying whether the blocks of data in the input structure complete at least one input message, and
notifying the completion of the at least one input message to an execution module.

11. The method according to claim 10, wherein the step of checking the state of the input buffer for each communication entity associated with the connection includes:
receiving a list managed at the operating system level, the list being indicative of the corresponding input buffers comprising at least one block of data.

12. The method according to claim 10, wherein the step of verifying the state of each associated connection by the activated reading processing entity further includes:
closing the connection if a frequency of the received blocks of data exceeds a threshold value.

13. The method according to claim 10, wherein the step of responding to each further request received in each connection associated with the activated reading processing entity includes:
inserting a reference to the at least one input message into a first queue at the operating system level in response to the notification of the completion of the at least one input message,
extracting an indication of one among a plurality of available execution processing entities from a second queue at the operating system level,
assigning the at least one input message to the execution processing entity,
processing the at least one input message by the execution processing entity, and
re-inserting the indication of the execution processing entity into the second queue at the end of the processing of the at least one input message.

14. The method according to claim 13, wherein the step of processing the at least one input message includes:
deriving an output message in response to the at least one input message, and
inserting the output message into an output buffer managed at the operating system level for at least one selected of the connections.

15. The method according to claim 14, wherein the at least one selected connection consists of a plurality of selected connections, the step of inserting the output message into the output buffer for the selected connections including:
causing the operating system to duplicate the output message into the output buffers for the selected connections.

16. In a distributed data processing system including a plurality of client computers and at least one server computer, a computer program product including a computer-usable medium embodying a computer program, the computer program when executed on the at least one server computer causing the at least one server computer to perform a communication method including the steps of:
receiving a connection request from a client computer,
establishing a connection with the client computer in response to the connection request,
classifying the connection according to a typology defined by a persistence thereof,
responding to the connection request directly or associating the connection with a reading processing entity having a corresponding latency according to the typology of the connection,
periodically activating each reading processing entity according to the corresponding latency,
verifying a state of each associated connection by the activated reading processing entity, and
responding to each further request received in each connection associated with the activated reading processing entity.

17. In a distributed data processing system including a plurality of client computers and at least one server computer, a server computer including means for receiving a connection request from a client computer, means for establishing a connection with the client computer in response to the connection request, means for classifying the connection according to a typology defined by a persistence thereof, means for responding to the connection request directly or associating the connection with a reading processing entity having a corresponding latency according to the typology of the connection, means for periodically activating each reading processing entity according to the corresponding latency, the activated reading processing entity verifying a state of each associated connection, and means for responding to each further request received in each connection associated with the activated reading processing entity.
